(19) United States
(12) Patent Application Publication
(10) Pub. No.: US 2024/0253434 A1
(43) Pub. Date: Aug. 1, 2024

(54) THERMOPLASTIC ROOFTOP

(71) Applicant: Magna Exteriors Inc., Aurora (CA)

(72) Inventors: John S. MUGLIA, Shelby Township, MI (US); Keijo J. HUOTARI, Fenton, MI (US); Brian STALEY, Bloomfield, MI (US); Larry Richard ERICKSON, Birmingham, MI (US); Marc COGSWELL, Bloomfield Hills, MI (US); Scott L. WOODS, Bruce Township, MI (US)

(73) Assignee: Magna Exteriors Inc., Aurora, ON (CA)

(21) Appl. No.: 18/418,571

(22) Filed: Jan. 22, 2024

Related U.S. Application Data
(60) Provisional application No. 63/441,578, filed on Jan. 27, 2023.

(51) Int. Cl. B60J 7/11; B60J 7/20; H01M 50/249; H02S 20/30

(52) U.S. Cl. CPC B60J 7/11; B60J 7/20; H01M 50/249; H02S 20/30; H01M 2220/20

(57) ABSTRACT

A roof panel for a vehicle having a frame includes an opening that extends between an inside surface and outside surface of the frame. The roof panel further includes a window extending across the opening on the outside surface of the frame. There are one or more grab handles molded into the inside surface of the frame. A battery module positioned between the inside surface and outside surface of the frame and a solar panel is connected to the outside surface of the frame. The solar panel being connected to be battery module for charging the battery. The roof panel further includes one or more lamps that are selectively illuminated and connected to the inside surface of the frame and charging ports connected to the inside surface of the frame. The lamps and charging ports are connected to and powered by the battery.

### FIELD OF THE INVENTION

The present invention relates to vehicle a roof panels having various integrated features that provide multi-purpose usage beyond being used as a vehicle roof.

### BACKGROUND OF THE INVENTION

Certain types of vehicles include removable roof panels. These panels can be removed to expose the occupants to the outside elements and thereby providing an open air feel. Often removable roof panels do not have any features, and instead are solid pieces with no lights or windows. When the panels are removed, they have no functionality, are large and cannot be stored in the vehicle, which is inconvenient if the weather changes and the user wants to have the roof reinstalled. Installation and removal of the panels can also be burdensome because it often requires two people to lift the panels over the top of the vehicle and drop them in place.

There is a need to provide panels that have additional features that are beneficial when attached to the vehicle and function as a vehicle roof, such as lights, charging ports, solar panels with battery power source, and window panels.

There is further a need to develop roof panels that can be easily stowed in the vehicle so that they are with the vehicle in case the user wants the roof reattached. It is desirable to provide a removable roof panel that has a window. It is further desirable to provide a roof panel that has lighting and hazard warning features.

There is further a need to develop roof panel systems that provide easier installation, removal and securing of the roof panels to the vehicle.

### SUMMARY OF THE INVENTION

A roof panel for a vehicle having a frame includes an opening that extends between an inside surface and outside surface of the frame. The roof panel further includes a window extending across the opening on the outside surface of the frame. There are one or more grab handles molded into the inside surface of the frame. A battery module positioned between the inside surface and outside surface of the frame; and a solar panel is connected to the outside surface of the frame. The solar panel is connected to be battery module for charging the battery. The roof panel further includes one or more lamps that are selectively illuminated and connected to the inside surface of the frame and charging ports connected to the inside surface of the frame. The lamps and charging ports are connected to and powered by the battery.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is a bottom plan view of a roof panel according to a first embodiment of the present invention.

FIG. 1B is a side bottom perspective view of a roof panel according to the first embodiment of the present invention.

FIG. 2A is a bottom plan view of a roof panel according to a second embodiment of the present invention.

FIG. 2B is a bottom plan view of a roof panel according to the second embodiment of the present invention.

FIG. 3A is a top side perspective view of a roof panel according to a third embodiment of the present invention.

FIG. 3B is a bottom side perspective view of a roof panel according to the third embodiment of the present invention.

FIG. 4A is a top side perspective view of a roof panel according to a fourth embodiment of the present invention.

FIG. 4B is a bottom side perspective view of a roof panel according to the fourth embodiment of the present invention.

FIG. 4C is a bottom side perspective view of a roof panel arrangement according to another embodiment of the invention.

FIG. 5A is a schematic side elevational view of a vehicle with roof panel storage.

FIG. 5B is an enlarged rear side perspective view of a vehicle with roof panel storage.

FIG. 6A is an environmental side perspective view of a roof panel according to a fifth embodiment of the present invention.

FIG. 6B is a top plan view of the roof panel according to the fifth embodiment of the present invention.

FIG. 7 is an environmental side perspective view of a roof panel according to the third embodiment of the present invention.

FIG. 8A is a schematic top perspective view of a vehicle with a roof panel arrangement.

FIG. 8B is an enlarged schematic top perspective view of a vehicle with a roof panel arrangement.

FIG. 8C is a top perspective view of a vehicle roof panel.

FIG. 8D is a bottom perspective view of a vehicle roof panel.

### DETAILED DESCRIPTION OF THE PREFERRED EMBODIMENTS

The following description of the preferred embodiments is merely exemplary in nature and is in no way intended to limit the invention, its application, or uses.

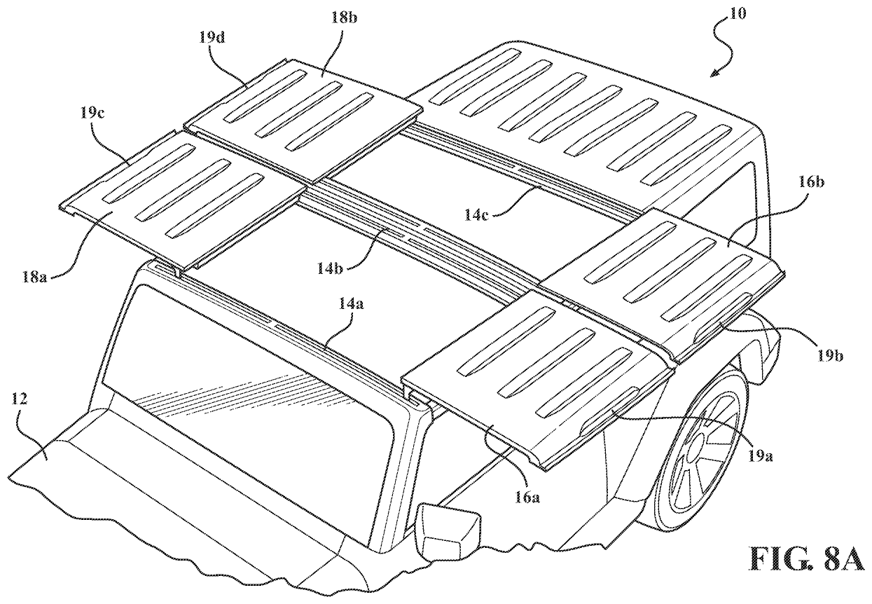

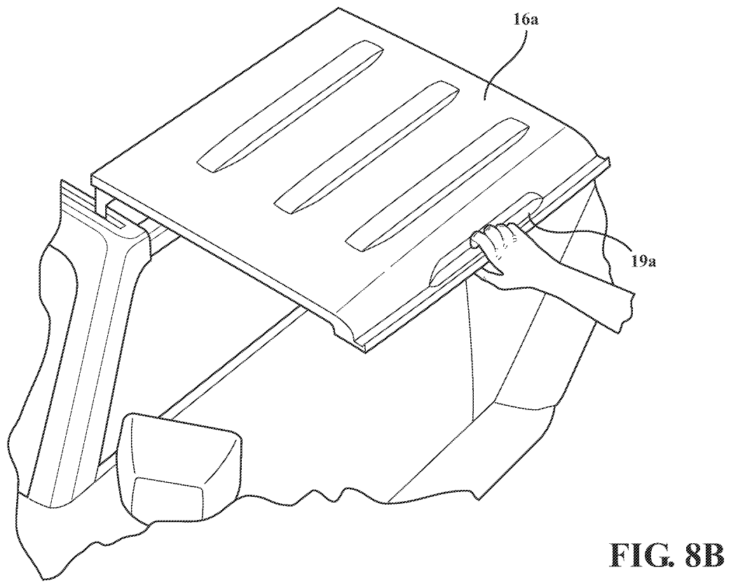

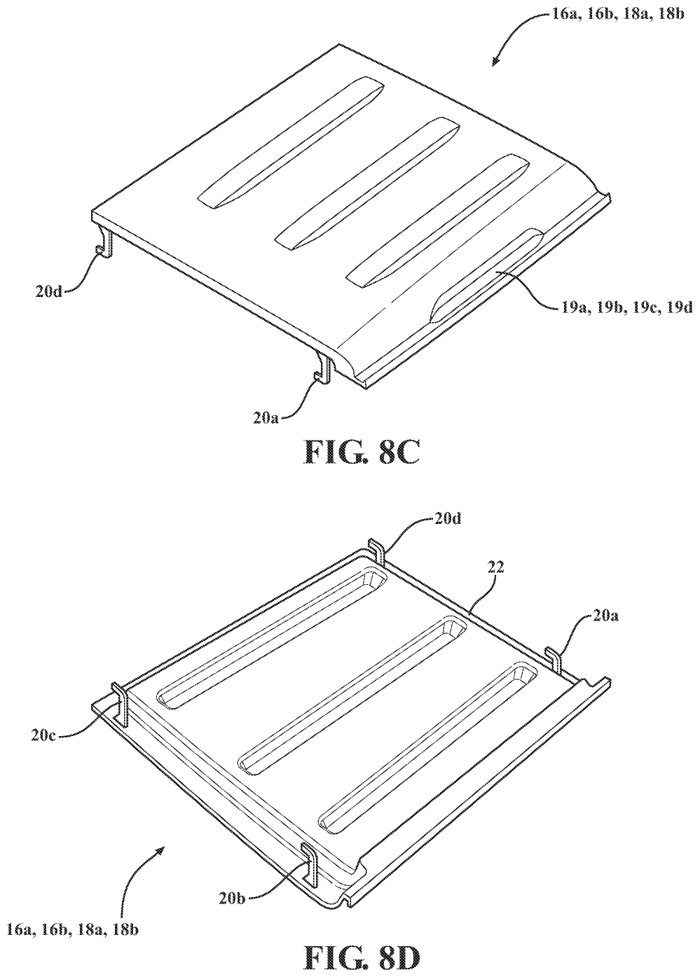

Referring now to FIGS. 8A and 8B generally, a first embodiment of the invention is directed to a roof panel arrangement 10 for a vehicle 12. It is contemplated that the vehicle is a type of vehicle 12 designed to have removable roof panels that will provide the user of the vehicle with the option to remove the roof panels and have what is oftentimes referred to as an “open air” feel, where the roof and portions of the sides are removed and exposes the occupants to the surrounding environment.

In order to provide for the removal of roof panels from the vehicle 12 the roof panel arrangement 10 includes cross-car tracks 14a, 14b, 14c mountable to the vehicle 12. While three cross-car tracks 14a, 14b, 14c are shown it is within the scope of this invention for there to be a greater or lesser number of cross car tracks, depending on the desired size and number of roof panels. Each of the cross car tracks 14a, 14b, 14c include an internal track, the purpose of which will be described below. Connected to each of the cross-car tracks 14a, 14b, 14c is a roof panel 16a, 16b, 18a, 18b which include two roof panels for the left side of the vehicle 12 and two roof panels for the right side of the vehicle 12.

FIGS. 8C and 8D show details of the roof panel 16a, 16b, 18a, 18b. Each roof panel 16a, 16b, 18a, 18b include locators 20a, 20b, 20c, 20d extending from a frame 22 of each roof panel 16a, 16b, 18a, 18b. Referring to FIG. 8A the roof panels 16a, 16b are shown on the left side of the vehicle 12, while roof panels 18a, 18b are shown on the right side of the vehicle 12. As shown in FIGS. 8C and 8D, the roof panels 16a, 16b, 18a, 18b can be identical and interchangeable. It is also within the scope of this invention for the roof panels 16a, 16b, 18a, 18b to be specifically shaped for a particular position on roof panel arrangement 10. While a total of four locators 20a, 20b, 20c, 20d are shown it is within the scope of this invention for there to be a greater or lesser number of locators depending on the size of the roof panel and the requirements of a specific application. Each individual roof panel 16a, 16b, 18a, 18b extends across a portion of the vehicle 12 and slidably connects between two respective cross car tracks 14a, 14b, 14c. Each individual roof panel 16a, 16b, 18a, 18b slides on the cross car tracks 14a, 14b, 14c between an engaged position forming a roof for the vehicle 12, and a disengaged position where the roof panel 16a, 16b, 18a, 18b is removed completely from the vehicle 12. The use of the cross car tracks 14a, 14b, 14c and the locators 20a, 20b, 20c, 20d assist the user with installation and removal of the roof panel 16a, 16b, 18a, 18b since they can be slid off the side of the vehicle 12 along the cross car tracks 14a, 14b, 14c; without the need to vertically lift the roof panel 16a, 16b, 18a, 18b away from the vehicle 12. Additionally, the cross car tracks 14a, 14b, 14c and the locators 20a, 20b, 20c, 20d aid and the alignment of the roof panel 16a, 16b, 18a, 18b on the vehicle 12. When the roof panel 16a, 16b, 18a, 18b is in the engaged position, the locators 20a, 20b, 20c, 20d on each roof panel 16a, 16b, 18a, 18b engage latch mechanisms in the cross car tracks 14a, 14b, 14c that are used to hold the roof panel 16a, 16b, 18a, 18b in place. Each roof panel 16a, 16b, 18a, 18b has an outer surface with a grab handle 19a, 19b, 19c, 19d molded into the outer surface that allows a user to pull the respective roof panel 16a, 16b, 18a, 18b off the respective cross car tracks 14a, 14b, 14c when installing or removing the roof panel from the vehicle 12. In FIGS. 8A and 8B grab handle 19a is shown on roof panel 16a and grab handle 19b is shown on roof panel 16b in FIG. 8A. Grab handle 19c is partially visible on roof panel 18a, and grab handle 19d is partially visible on roof panel 18b.

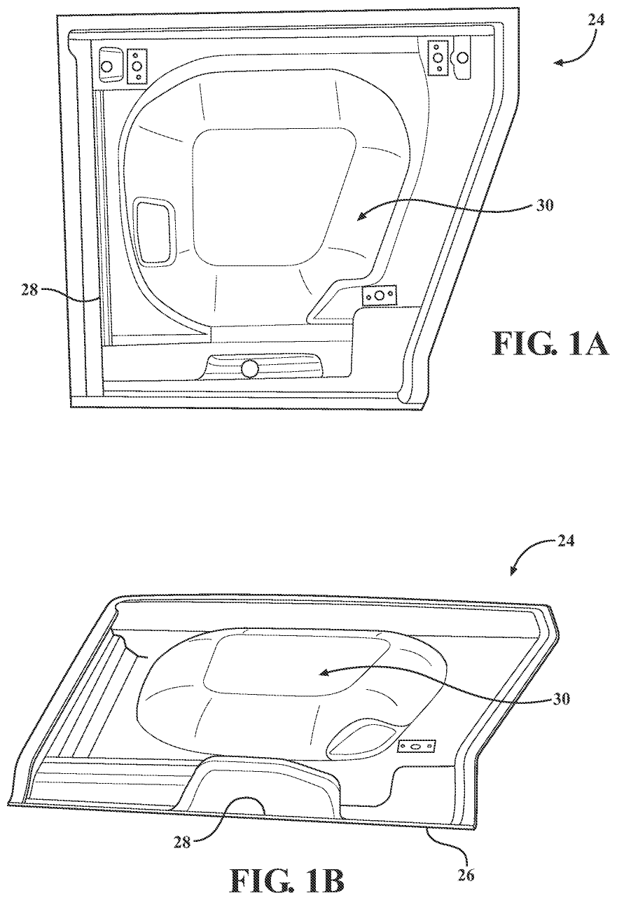

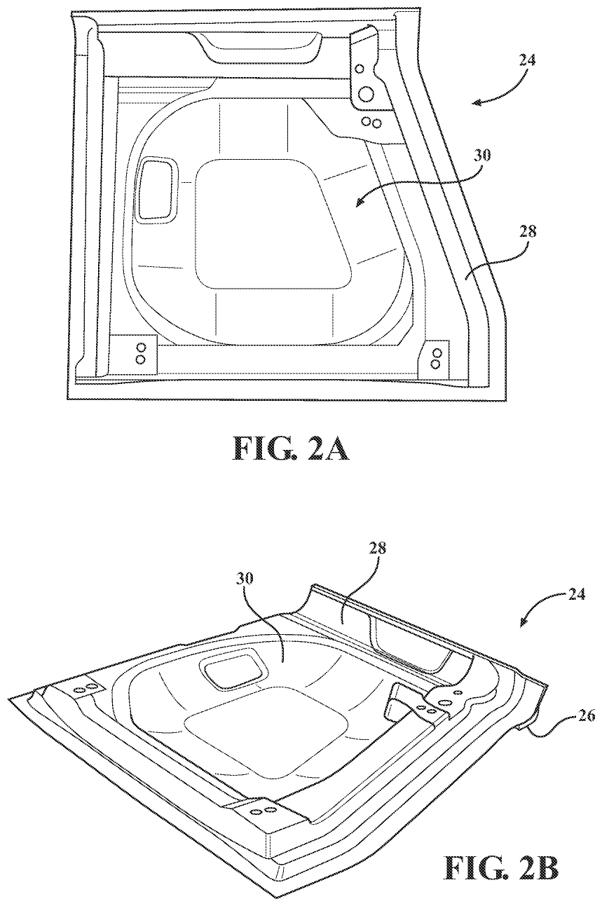

The roof arrangement 10 described above can utilize many different types of roof panels each having different features, which are now described in detail below. FIGS. 1A, 1B, 2A and 2B depict a roof panel 24 having an upper skin 26 and lower skin 28 each formed separately, which can be used in the roof panel arrangement 10. The upper skin 26 and lower skin 28 can be formed by processes including thermoforming, compression molding, injection molding and forming from sheet mold compound (SMC). The upper skin 26 has integrated joining features formed on a joining surface and an exterior surface optionally has molded handles similar to the handles 19a, 19b, 19c, 19d described above with references to roof panel 16, 16b. The lower skin 28 also has integrated joining features formed on a joining surface. The integrated joining features on the upper skin 26 and the integrated joining features on the lower skin 28 align and join or lock the upper skin 26 with the lower skin 28. The lower skin 28 also includes an inside surface 30 that forms a continuous headliner surface for an interior cabin of the vehicle 12.

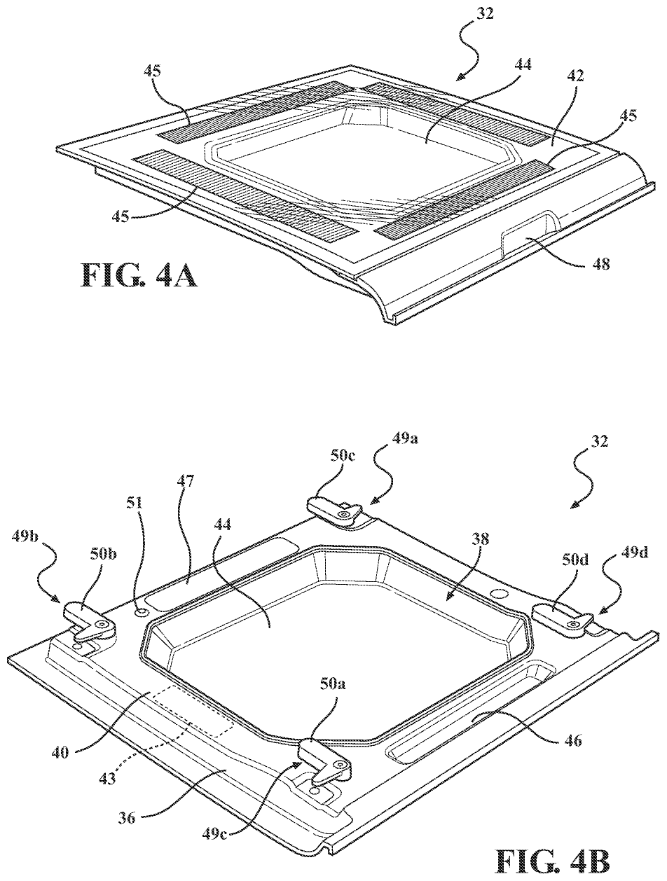

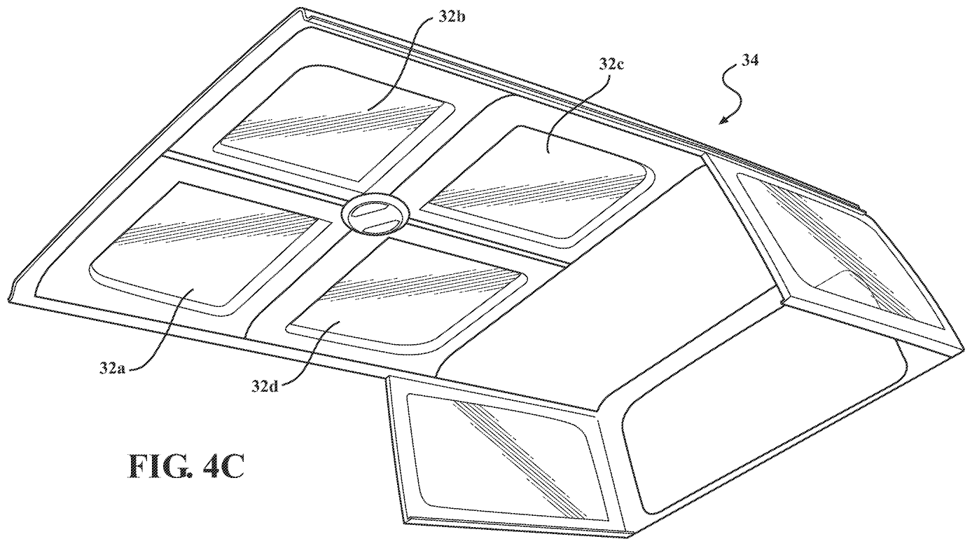

FIGS. 4A and 4B depict a roof panel 32, which is an alternate embodiment of roof panel 16a, 16b, 18a, 18b and can be used in the roof panel arrangement 10. FIG. 4C is a perspective inside view of four roof panels 32a, 32b, 32c, 32d installed on a vehicle roof 34. The four roof panels 32a, 32b, 32c, 32d have the same features and construction as roof panel 32, which will now be discussed in further detail. The roof panel 32 each has a frame 36 having an opening 38 formed in the frame 36 that extends between an inside surface 40 of the frame 36 and an outside surface 42 of the frame 36. There is a window 44 extending across the opening 38 on the outside surface 42 of the frame 36. The window can be formed of glass, polycarbonate, smart glass or any other suitable transparent or semi-transparent material. Formed or molded into the inside surface 40 of the frame 36 is an inside grab handle 46, which is optional. The inside grab handle 46 is shown as a single handle but can also be multiple handles depending on the need of a particular application. Formed or molded into the outside surface 42 of the frame 36 is an outside grab handle 48 that is optional. The outside grab handle 48 is shown as a single handle but can also be multiple handles depending on the need of a particular application.

The roof panel 32 also includes four latch mechanisms 49a, 49b, 49c, 49d each having a respective handle 50a, 50b, 50c, 50d, which can also be a single handle latch mechanism. The latch mechanisms 50a, 50b, 50c, 50d are rotated between locked and unlocked positions to lock the roof panel 32 in place.

The roof panel also includes solar panels 45 connected to the frame 36 on the outside surface 42 about the periphery of the window 44. The solar panels 45 are connected to a and charges a battery 43 that is contained within the frame 36 between the inside surface 40 and the outside surface 42. The battery 43 is connected to and powers a light 47 located on the inside surface 40. The light 47 is turned off and on using a switch 52 also formed on the inside surface 40.

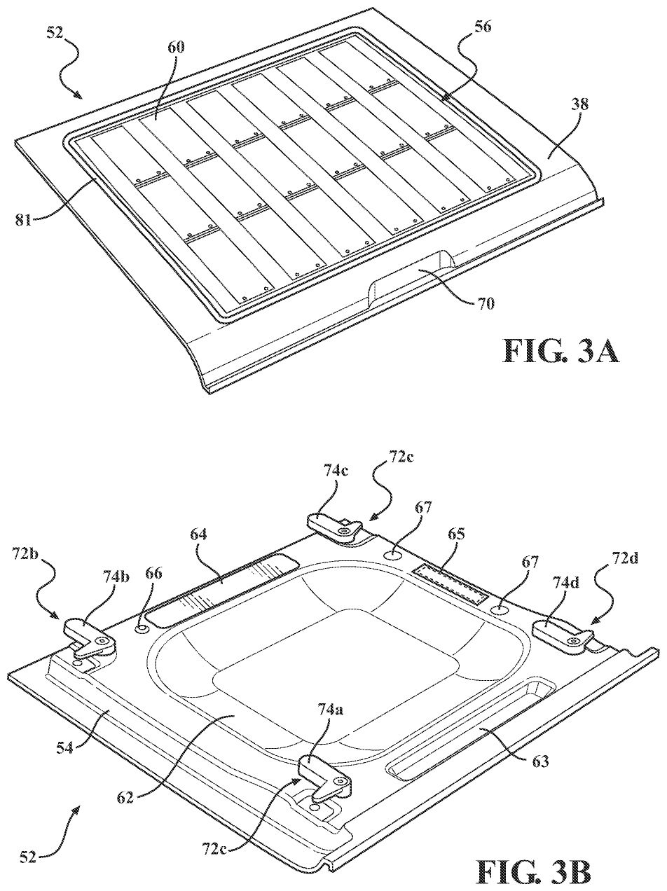

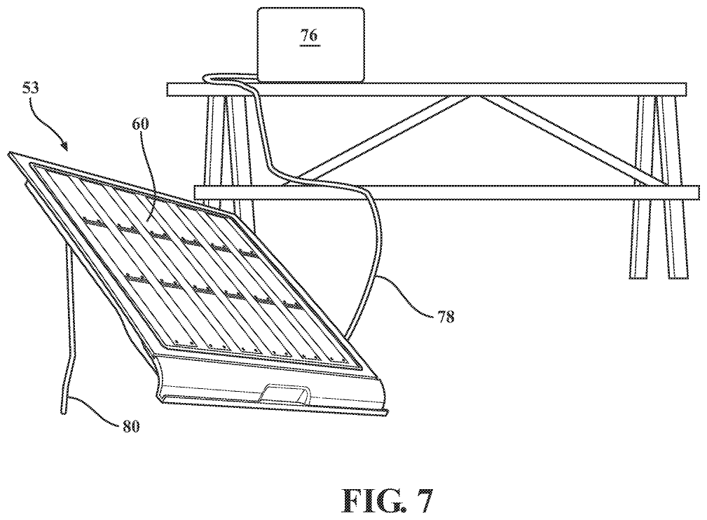

Referring now to FIGS. 3A, 3B and 7 a roof panel 52, which is an alternate embodiment of roof panels 16a, 16b, 18a, 18b, 32 and can be used in the roof panel arrangement 10. In this particular embodiment the roof panel 52 has a frame 54 having an opening 56 on an outside surface 58. Within the opening is a solar panel 60 that is mounted thereon and is connected to a power source 65 that is a battery that is positioned within a cavity of the roof panel 52 and accessible from the inside surface 62. The cavity is located between the outside surface 58 and an inside surface 62 of the roof panel 52. The power source 65 is also connected to and powers a light 64 that is mounted to the inside surface 62 and is controlled by a switch 66. FIGS. 3A and 3B show another application of the roof panel 52. In this embodiment the roof panel 52 is being used to provide exterior lighting. Around the edge of the opening 56 and the solar panel 60 is a light ring 81 that is connected to the power source 65 and can be selectively illuminated by the switch 67.

The power source 65 also provides power to an accessory port 67 that can be a USB port, DC power plug, or any other power output port. This way the panel 52 is usable as a rechargeable power source when removed from the vehicle 12. For example, FIG. 7A shows an embodiment where the roof panel 52 is removed from the vehicle 12 and an electronic device 76 is connected to the power source 65 using a cord 78 that is plugged into the accessory port 67. There is also a prop rod 80 connected to the roof panel 52 that is used to prop the roof panel 52 at an angle so that the solar panel 60 can be positioned facing the sun so that the power source 65 can be replenished.

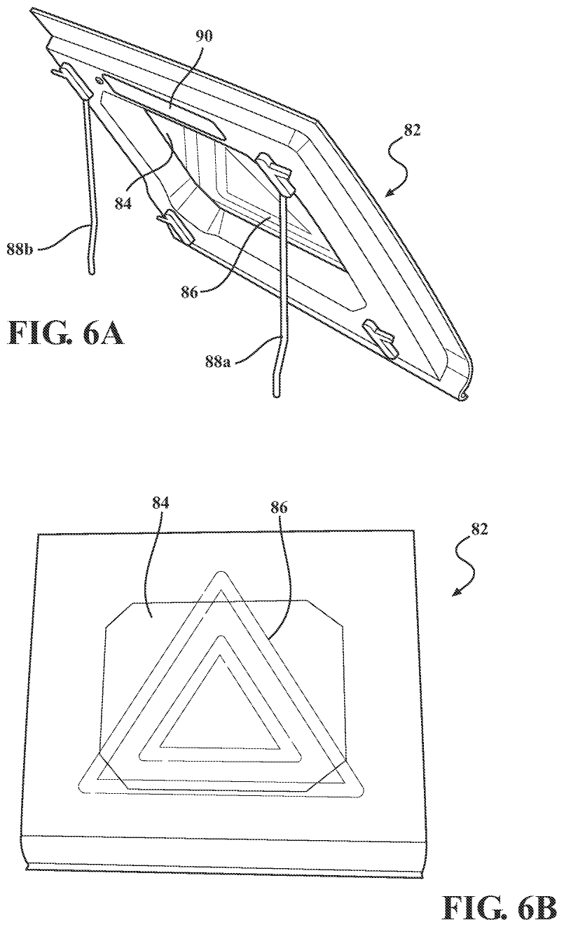

Referring now to FIGS. 6A and 6B there is another embodiment of a roof panel 82 that has a window 84 with a graphic 86 that can be illuminated. In this particular embodiment the graphic 86 is a hazard warning symbol that is illuminated by a light source. The roof panel 82 includes two prop rods 88a, 88b that are used to stand the roof panel 82 at an angle to the ground so that the graphic 86 is visible. The roof panel 82 also includes a light 90 on one side that is selectively illuminated and projects light to provide illumination in a user specific direction.

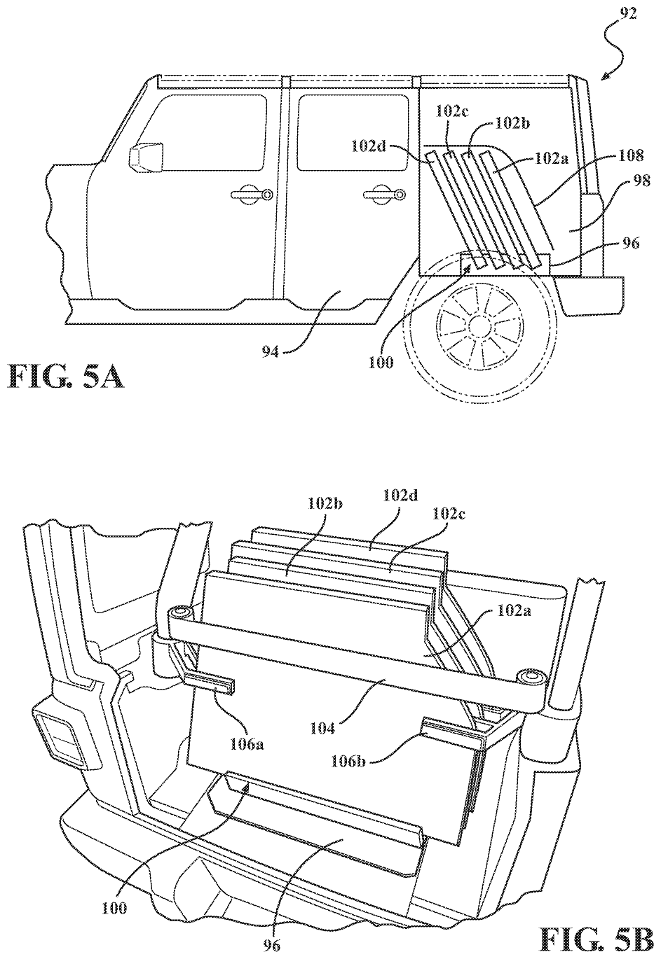

Referring now to FIGS. 5A and 5B a panel storage arrangement 92 for a vehicle 94 is shown. The vehicle 94 has a storage divider 96 connected to a rear storage compartment 98 of the vehicle 94. The rear storage divider 96 has molded slots 100 that are configured to receive an edge of one of four roof panels 102a, 102b, 102c, 102d that are stored on the storage divider 96. The panel storage arrangement 92 further includes a belt 104 that extends across the four roof panels 102a, 102b, 102c, 102d to prevent them from tipping. There are also arms 106a, 106b that are rotated into position and prevent the roof panels 102a, 102b, 102c, 102d from tipping. Also shown is a storage bag 108 that is shown as a single bag but could be multiple bags that are placed over the roof panels 102a, 102b, 102c, 102d to hold them in position and prevent them from any damage. The storage bag 108 is optional.

In another embodiment of the invention all of the above described roof panels include a shade moveable between a retracted position and an extended position. The shade includes at least one roller rotatably positioned within the interior of the frame and biased to rotate toward the retracted position. The shade also has a flexible material having a roll connection end that is connected to the at least one roller and a free end extending through a shade opening in the frame. The free end is moveable to the extended position where the flexible material is unrolled from the at least one roller and a portion of the flexible material extends through the opening away from the inside surface of the frame.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A roof panel for a vehicle comprising:
a frame of a roof panel connectable to a vehicle, the frame includes an opening formed in the frame that extends between an inside surface of the frame and an outside surface of the frame;
a window extending across the opening on the outside surface of the frame;
one or more grab handles molded into the inside surface of the frame;
a battery module positioned between the inside surface and outside surface of the frame;
a solar panel connected to the outside surface of the frame, the solar panel being connected to be battery module for charging the battery;
one or more lamps that are selectively illuminated and connected to the inside surface of the frame, the one or more lamps are connected to and powered by the battery, and
one or more charging ports connected to the inside surface of the frame, the one or more charging ports are connected to and powered by the battery.

2. The roof panel of claim 1, further comprising at least latch mechanism connected to the frame and having a handle on the inside surface of the frame for moving the latch mechanism between a locked position securing the roof panel to the vehicle and an unlocked position that releases the roof panel from the vehicle.

3. The roof panel of claim 1, wherein the window is formed of smart glass.

4. The roof panel of claim 1, wherein the window is transparent and allows ambient light from outside the vehicle to pass through the viewing surface of the window.

5. The roof panel of claim 1, further comprising a projector connected to the inside surface of the frame for projecting images away from the inside surface of the frame.

6. The roof panel of claim 1, further comprising a projector connected to the outside surface of the frame for projecting images away from the outside surface of the frame.

7. The roof panel of claim 1, further comprising prop rod connected to the inside surface of the frame or the outside surface of the frame, wherein the prop rod allows the roof panel to be positioned so at least one edge is raised from a ground surface.

8. The roof panel of claim 1 further comprising a plurality of joining points between the inner surface of the frame and the outer surface of the frame.

9. The roof panel of claim 1 wherein the inner surface of the frame has a headliner surface layer connected thereon to provide a continuous headliner surface.

10. The roof panel of claim 1 further comprising:
at least one shade moveable between a retracted position and an extended position, the at least one shade including:
at least one roller rotatably positioned within the interior of the frame and biased to rotate toward the retracted position;
a flexible material having a roll connection end that is connected to the at least one roller and a free end extending through a shade opening in the frame, wherein the free end is moveable to the extended position where the flexible material is unrolled from the at least one roller and a portion of the flexible material extends through the opening away from the inside surface of the frame.

11. A roof panel arrangement for a vehicle comprising:
at least one cross-car tracks mountable to a vehicle;
at least one roof panel comprising:
a frame of the at least one roof panel having at least one cross-car track engaging features that are connectable to the at least one cross-car track by sliding into the at least one cross-car track so that the at least one roof panel is moveable between an installed position where the at least one roof panel is fully engaged with the at least one cross-car track and a disengaged position where the at least one roof panel is completely removed from the at least one cross-car track, wherein the frame includes an opening formed in the frame that extends between an inside surface of the frame and an outside surface of the frame;
a window extending across the opening on the outside surface of the frame;
one or more grab handles molded into the outside surface of the frame, and
at least latch mechanism connected to the frame and having a handle on the inside surface of the frame for moving the latch mechanism between a locked position securing the at least one roof panel to a vehicle and an unlocked position that releases the at least one roof panel from the vehicle.

12. The roof panel arrangement of claim 11 further comprising:
a battery module positioned between the inside surface and outside surface of the frame;
a solar panel connected to the outside surface of the frame, the solar panel being connected to be battery module for charging the battery;
one or more lamps that are selectively illuminated and connected to the inside surface of the frame, the one or more lamps are connected to and powered by the battery, and
one or more charging ports connected to the inside surface of the frame, the one or more charging ports are connected to and powered by the battery.

13. The roof panel of claim 11, wherein the window is transparent and allows ambient light from outside the vehicle to pass through the viewing surface of the window.

14. The roof panel arrangement of claim 11, further comprising a projector connected to the inside surface of the frame for projecting images away from the inside surface of the frame.

15. The roof panel arrangement of claim 11, further comprising a projector connected to the outside surface of the frame for projecting images away from the outside surface of the frame.

16. The roof panel arrangement of claim 11, further comprising prop rod connected to the inside surface of the frame or the outside surface of the frame, wherein the prop rod allows the roof panel to be positioned so at least one edge is raised from a ground surface.

17. The roof panel arrangement of claim 11, further comprising a plurality of joining points between the inner surface of the frame and the outer surface of the frame.

18. The roof panel arrangement of claim 11, wherein the inner surface of the frame has a headliner surface layer connected thereon to provide a continuous headliner surface.

19. The roof panel arrangement of claim 11 further comprising:
at least one shade moveable between a retracted position and an extended position, the at least one shade including:
at least one roller rotatably positioned within the interior of the frame and biased to rotate toward the retracted position;
a flexible material having a roll connection end that is connected to the at least one roller and a free end extending through a shade opening in the frame, wherein the free end is moveable to the extended position where the flexible material is unrolled from the at least one roller and a portion of the flexible material extends through the opening away from the inside surface of the frame.

20. The roof panel arrangement of claim 11 further comprising:
a storage envelope located in the vehicle, the storage envelope has a surface with at least one receiving surface for securely holding the at least one panel and a locking mechanism for releasably holding the at least one panel to the storage envelope.
